(19) United States
(12) Patent Application Publication
(10) Pub. No.: US 2013/0108073 A1
(43) Pub. Date: May 2, 2013

(54) METHOD AND APPARATUS FOR PROVIDING AUDIO FROM ONE OR MORE SPEAKERS

(71) Applicants: Jan Abildgaard Pedersen, Holstebro (DK); Morten Lydolf, Holstebro (DK)

(72) Inventors: Jan Abildgaard Pedersen, Holstebro (DK); Morten Lydolf, Holstebro (DK)

(73) Assignee: BANG & OLUFSEN A/S, Struer (DK)

(21) Appl. No.: 13/806,563

(22) PCT Filed: May 31, 2011
(86) PCT No.: PCT/EP2011/058974

§ 371 Date: Dec. 21, 2012

(30) Foreign Application Priority Data
Jul. 9, 2010 (DK) PA 2010 00611

(51) Int. Cl. H04R 3/12

(52) U.S. Cl. CPC H04R 3/12
USPC 381/80

(57) ABSTRACT

A method and a system for adapting the timbre of sound output at power-up/down of a media player or stereo, where the timbre adaptation is a limitation of the bandwidth of the signal or sound, which bandwidth limitation is reduced over time to eventually provide no filtering at all.

The present invention relates to a method and an apparatus for providing audio from one or more speakers and in particular for providing a distinguishable start-up effect when turning on a stereo, media player or the like and/or a distinguishable shut-down effect when turning it of.

The present invention adds an audible timbre effect to a sound system at start-up, shut-down or while changing the configuration of the play-back strategy. By configuration of the play-back strategy means the choice of the play-back of e.g. mono, stereo, 3.0, 4.0, 5.1, 7.1 audio formats via a sound system that is able to play back more than one of these formats.

The invention is an audible timbre effect which can be implemented by digital signal processing that e.g. reveals a sound scene by gradually expanding the frequency bandwidth or another change of timbre of the audio signal at start-up and similarly reducing the frequency bandwidth or another change of timbre at the shut-down. By changing the timbre means making an action towards changing the perceived timbre which is different to that caused by the nature of the auditory system itself.

The present invention is a method, different to the prior art technique of a simple fade-in and fade-out implemented by gain control.

A first aspect of the invention relates to a method of providing audio from one or more speakers, the method comprising:
1. initially providing no sound from the speaker(s),
2. after step 1., providing sound relating to a track characterized by a predetermined signal, step 2 comprising: initially providing the sound by bandwidth limiting the predetermined signal and feeding the bandwidth limited signal to the speaker(s) and subsequently feeding the predetermined signal to the speaker(s).

In the present context, a speaker is a loudspeaker or other element adapted to convert an electrical signal to sound. Speakers are made in a large variety of sizes and with a large variety of capabilities. Some speakers are able to output sound within more or less all of the audible frequency interval, whereas others are intended for outputting sound in only part of this frequency interval. Some speakers actually comprise a number of speakers.

In this context, audio is an audible signal, sound, generated on the basis of a corresponding signal, usually an electrical signal carried on wires, but audio can also be transported via optical signals either in optical wires or wirelessly. Also other wireless standards exist, such as HF, UHF, WLAN or the like.

Normally, the signal will have a time dependency describing the sound to be output, such as is the situation with streamed analogue radio signals, but the signal may also be digital, such as streamed digital signals, such as a bit stream, or e.g. packet based, as would be the situation if the signal is fed via e.g. the internet, whereby a further processing is required to provide a (analogue) signal suitable for feeding to a standard speaker. Both types of signals may be filtered to adapt the bandwidth thereof.

The present method may be performed using any number of speakers. Usually, media players, stereos or the like will have at least two speakers, but in order to obtain a more surround sound-like environment, 4, 5, 6, 7, 8 speakers or more may be desired.

When no sound is provided from the speakers, usually no signal is fed to the speakers, or a signal so low is fed that no audible sound is output. If the speaker is active, i.e. has its own amplifier, no sound will also be output even if a signal is fed to the speaker, if the amplifier is not powered.

The step of initially providing no sound from the speakers may have any time duration. In a preferred embodiment, step 2 is performed at start-up or power-up of a stereo or media player, whereby step 1 may represent the stereo/media player when turned of. The stereo/media player naturally may be in the powered-down state for any period of time.

The initial step of step 2 comprises bandwidth limiting the signal (whether analogue, digital, packet based or the like) and feeding this to a speaker, possibly with additional processing, such as amplification, D/A conversion or the like. This step may take a predetermined period of time, such a between 1 and 30 second, such as between 2 and 10 seconds, preferably between 3 and 5 seconds.

Subsequent to the initial step of step 2, the actual signal is fed to the speakers. Thus, no bandwidth limitation is performed. In this respect, the signal may be a signal accessed or received from a storage, external storage, radio/TV channel, the internet or the like, or a signal of that type may have been filtered in a desired manner, as long as this additional filtering is performed during all of step 2. This additional filtering may be performed to adapt the sound to surroundings of the speakers, but it is not used in the temporary bandwidth limitation of step 2. This subsequent step may take any period of time. Usually, this step may continue through the providing of multiple different tracks or the like and until powering off of the stereo/media player.

It is noted that it is, naturally, possible to always feed the signal to the speakers and then bandwidth limit the sound output by the speakers by adapting the speakers or their surroundings.

Preferably, step 2 is performed or initiated in connection with a start-up or power-up of a stereo, media player, TV, or the like, whether present in a room, a theatre, a car, a vehicle, a boat, an airplane or the like.

Step 2 comprises initially bandwidth limiting the signal and subsequently not bandwidth limiting the signal. The transition between these two phases may be continuous or stepwise in one or more steps. The transition may however, as will be described further below, take place differently for different ones of the speakers, if more than one is used.

In one embodiment, the bandwidth limiting step comprises filtering the signal in a band pass filter. The below-mentioned frequency limits may be used also in this band pass filter.

In that or another embodiment, the bandwidth limiting step may comprise reducing frequencies of the signal having a frequency exceeding a higher threshold frequency. This may be a low-pass filter. Then, the bandwidth limiting step preferably comprises increasing, during a first predetermined period of time, the higher threshold from a first lower limit to a first upper limit. Preferably, the first lower limit is between 1000 and 10,000 Hz, such as between 2000 and 5000 Hz, preferably 3000-4000 Hz. Also, the first upper limit may be 10,000-30,000 Hz, such as 15,000-25,000 Hz, preferably 18,000-21,000 Hz.

In that or another embodiment, the bandwidth limiting step comprises reducing frequencies of the signal having a frequency being lower than a lower threshold frequency. This may be a high-pass filter. Then, the bandwidth limiting step preferably comprises decreasing, during a second predetermined period of time, the lower threshold from a second higher limit to a second lower limit. Preferably, the second lower limit is between 0 and 100 Hz, such as between 10 and 50 Hz, preferably between 15 and 25 Hz. Also, the second upper limit may be between 50 and 1000 Hz, such as between 100 and 500 Hz, preferably 250-350 Hz.

Any type of filter may be used. Combinations of the above band pass, low pass and high pass filters including also shelving filters, may be used. In fact, the filtering characteristic (reduction/increase at the individual frequencies) may be tailored exactly as desired using e.g. digital filters.

The first and second periods of time may be identical or not. One period of time may follow the other, or an overlap may exist.

As mentioned above, the transition in step 2 may be performed identically for all speakers, i.e. from the same bandwidth limitation and within the same period of time with the same time dependency of the bandwidth limitation change, or different speakers may receive signals with different transitions.

In multi speaker set-ups, it may be preferred that speakers more to the front of the person transition the fastest to the subsequent state where no bandwidth limitation is performed. Thus, speakers more to the side or to the back of the person may transition slower or perform the transition at a later point in time compared to the speakers more in front of the person.

Also, it may be desired that the transitions are different in other manners, such as where the signals for some speakers transition faster from the initial to the subsequent state than the signals for other speakers, and/or where the signals for some speakers transition smoothly over time where the signals for other speakers transition step-wise.

Any time “curve” of the strength or impact of the bandwidth limitation may be used: smooth, step-wise, more steps, fewer steps, faster at the beginning, faster at the end, or the like.

The bandwidth limiting transition may be accompanied by other effects.

In one embodiment, the bandwidth limiting step comprises increasing, during a third predetermined period of time, an overall signal intensity of the signal fed to the speaker(s).

In general, the signal intensity/strength/amplitude of an analogue signal may be measured in volts or amperes, and that of a digital signal may be measured in the value thereof. Alternatively, the signal intensity may be determined as the resulting sound pressure (measured in dB) output by the speakers.

The third period of time may overlap the first and/or second periods of time or not. The increase in signal intensity/strength may be performed before or during the bandwidth limiting transition. If the increase is an increase from a non-zero intensity/strength, the increase may also take place after the bandwidth limiting transition.

In one embodiment which is for providing audio from a plurality of speakers, the bandwidth limiting step comprises increasing, during a fourth predetermined period of time, a number of the speaker(s) to which the bandwidth limited signal is fed.

When no signal is fed to a speaker, it is silent. Thus, when increasing the number of speakers receiving a signal during a period of time, more and more speakers become active and output sound. Thus, over the fourth period of time, more and more speakers output sound.

The fourth period of time may overlap with the first/second/third period of time or not.

It may be desired that the bandwidth limiting transition does not take place before the signal fed to a speaker has reached a predetermined level/strength/intensity, or an increase in signal intensity fed to a speaker may take place during the bandwidth limiting transition and thus take place sequentially over time for different speakers.

In another aspect, the invention relates to an apparatus for providing audio from one or more speakers, the apparatus comprising:
a signal provider able to access a track to be provided and output a corresponding signal,
a filter for filtering the output signal and provide a filtered signal to the speaker(s), the filter being adapted to:
1. initially provide no signal to the speaker(s),
2. after step 1., initially filter the output signal and feed the filtered signal to the speaker(s) and subsequently feed to the speaker(s), as the filtered signal, the output signal without filtering it.

In this respect, the signal provider may be, as is described above, any type of media player or the like able to access or receive a track, which may be a complete file or a streamed file or signal, and which is able to output a corresponding signal which when output to a speaker, potentially after having been D/A-converted, will provide the sound of the track.

It is noted that the signal may be analog or digital, whether as a stream of values, such as a so-called bit stream, or in the form of packets/cells or the like. It is noted that all such signal types may be filtered or have the resulting bandwidth adapted.

The filter thus may be any type of frequency filter, from the simplest RC-circuit to a complex DSP which performs the filtering by firstly performing a Fourier transformation of the signal, performs an adaptation of the Fourier transformed signal and converts it back into the original format. The filter may also, as will be described further below, filter the signal by adding or subtracting the same or another signal.

The filter thus outputs the signal to the speakers. Therefore, the filter may additionally comprise further elements or circuits for adapting the signal for the speakers. Such elements may be amplifiers and/or pre-amplifiers which may be used for adapting the volume of the sound output by the speakers. Also, a further filtering of the sound may be provided to adapt the sound to surroundings of the speakers, such as a cabin of a car or a room. This filtering, however, is present during all providing of audio, i.e. during both steps of step 2.

Initially, no signal is provided to the speaker(s), whereby no sound is output. This may be when the system is turned off.

Subsequent to step 1, such as immediately after, the filter initially filters the signal and feeds the filtered signal to the speakers. This filtering may be a bandwidth adaptation or limitation by which the contents in the filtered signal at one or more bandwidths or in one or more bandwidth intervals, have been amplified or reduced. If certain bandwidths or bandwidth intervals are reduced, the process is a bandwidth limitation. A number of such filters and methods are described below.

After the filtering step, the filter finally will output the signal without filtering it. Thus, the signal output may be the same, at least in relation to frequency contents, as that received. Naturally, as is described above, an amplification may be performed. Also, an additional, more permanent, filtering may be performed either in this filter or e.g. before the signal reaches the filter.

Different actions may trigger the transition from step 1 to step 2, such as turning the media player or the like on or altering a setting thereof, such as altering a playback mode from the use of a first number of speakers to another number of speakers.

Thus, the apparatus may have a plurality of speakers, where the filter or the signal provider is adapted to operate in different modes where different numbers of speakers are used.

In a particular embodiment, one or more of the speakers are adapted to move physically between an active and an inactive position. In this situation, the transition from step 1 to step 2 may, at least for such a speaker, take place when the speaker moves from the inactive to the active position.

In addition, the apparatus may have an on/off button for turning the apparatus on and off.

In one embodiment, the filter is a band pass filter.

In that or another embodiment, the filter a low pass filter. This may be performed by reducing frequencies of the signal having a frequency exceeding a higher threshold frequency. In this embodiment, the filter preferably is adapted to, during step 2. and during a first predetermined period of time increase a threshold frequency of the low pass filter. This may be obtained by increasing, during the first predetermined period of time, the higher threshold from a first lower limit to a first upper limit. The preferred the first lower limit and first upper limit are described above.

In that or another embodiment, the filter is adapted to, during step 2. high pass filter the output signal. This may be obtained by reducing frequencies of the signal having a frequency being lower than a lower threshold frequency. In this embodiment, the filter preferably is adapted to, during step 2. and during a second predetermined period of time decrease a threshold frequency of the high pass filter. This may be obtained by decreasing, during the second predetermined period of time, the lower threshold from a second higher limit to a second lower limit. The preferred second lower limit and second upper limit are described above.

In one embodiment, the filter is adapted to, during a third predetermined period of time of step 2., increase an overall signal intensity of the filtered signal fed to the speaker(s). This may be performed in the above-mentioned amplification which may also be performed in the filter.

As mentioned above, these embodiments may be combined and the first, second and/or third periods of time may be identical, overlap or not.

As is also mentioned above, the apparatus preferably comprises a plurality of speakers, wherein the filter is adapted to increase, during a fourth predetermined period of time, a number of the speaker(s) to which the filtered signal is fed.

It is noted that the reverse operation may be performed when shutting down the apparatus. Thus, a third aspect relates to a method of providing audio from one or more speakers, the method comprising:
1. initially providing sound from the speaker(s), the sound relating to a track characterized by a predetermined signal,
2. after step 1., initially providing the sound by bandwidth limiting the signal and feeding the bandwidth limited signal to the speaker(s) and subsequently feeding no signal to the speaker(s).

Thus, compared to the first aspect, step 1 and the last step of step 2 have been exchanged, so that step 1 now relates to the usual providing of the sound corresponding to the signal. When e.g. the user turns the system off, step 2 initiates by firstly filtering the signal and finally provides no signal, so that the system is silent.

The filtering types may be as those described further above with the possible difference being that the filtering now over time increases the impact on the signal where, in the first and second aspects, the impact preferably was reduced over time.

Thus, the bandwidth limiting step may comprise filtering the signal in a band pass filter.

In that or another embodiment, the bandwidth limiting step comprises reducing frequencies of the signal having a frequency exceeding a higher threshold frequency. Then, the bandwidth limiting step could comprise decreasing, during a first predetermined period of time, the higher threshold from a first upper limit to a first lower limit. The preferred first lower limit and first upper limit are described above.

In that or another embodiment, the bandwidth limiting step comprises reducing frequencies of the signal having a frequency being lower than a lower threshold frequency. Then, the bandwidth limiting step could comprise increasing, during a second predetermined period of time, the lower threshold from a second lower limit to a second higher limit. The preferred second lower limit and second upper limit are described above.

Also, it could be desired that the bandwidth limiting step comprises decreasing, during a third predetermined period of time, an overall signal intensity of the signal fed to the speaker(s).

Also, or alternatively, the method could be for providing audio from a plurality of speakers, wherein the bandwidth limiting step comprises decreasing, during a fourth predetermined period of time, a number of the speaker(s) to which the bandwidth limited signal is fed.

A fourth aspect of the invention then relates to an apparatus for providing audio from one or more speakers, the apparatus comprising:
a signal provider able to access a track to be provided and output a corresponding signal,
a filter for filtering the output signal and provide a filtered signal to the speaker(s), the filter being adapted to:
1. initially provide the output signal the speaker(s) without filtering it,
2. after step 1., initially filter the output signal and feed the filtered signal to the speaker(s) and subsequently feed no signal to the speaker(s).

The signal provider and filter may be of the same types as described above.

In one embodiment, the filter is a band pass filter.

In that or another embodiment, the filter is adapted to, during step 2. low pass filter the output signal. In that situation, the filter could be adapted to, during step 2. and during a first predetermined period of time decrease a threshold frequency of the low pass filter.

In that or another embodiment, the filter is adapted to, during step 2. high pass filter the output signal. In that situation, the filter could be adapted to, during step 2. and during a second predetermined period of time increase a threshold frequency of the high pass filter.

Again, the filter could be adapted to, during a third predetermined period of time of step 2. decrease an overall signal intensity of the filtered signal fed to the speaker(s).

Also, the apparatus could comprise a plurality of speakers, wherein the filter is adapted to decrease, during a fourth predetermined period of time, a number of the speaker(s) to which the filtered signal is fed.

In the following, preferred embodiments of the invention will be described with reference to the drawing, wherein:

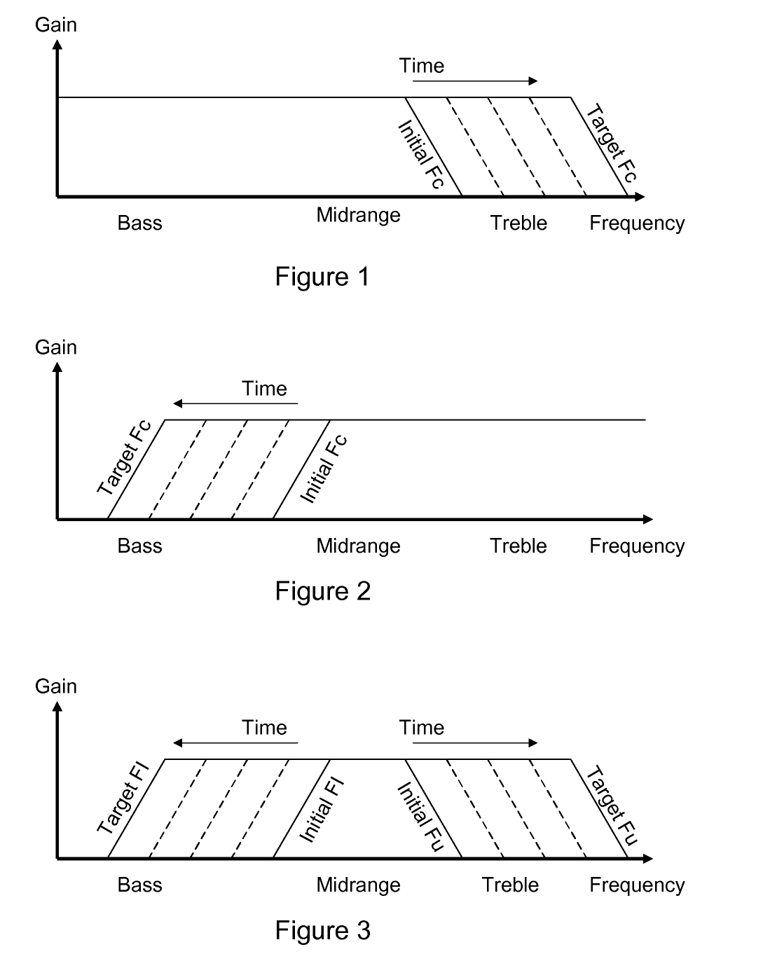

FIG. 1 illustrates the effect of a low-pass filter,

FIG. 2 illustrates the effect of a high-pass filter,

FIG. 3 illustrates the effect of a band-pass filter,

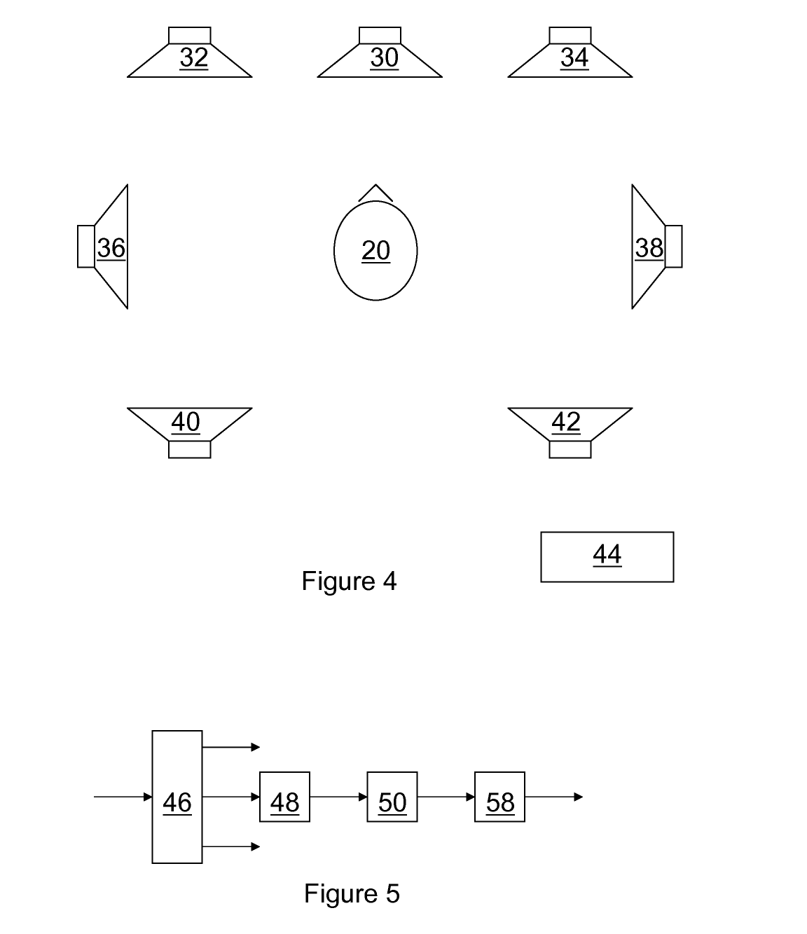

FIG. 4 illustrates a system incorporating the invention and

FIG. 5 illustrates the signal path for a single speaker.

As the present invention relates to the altering of the timbre of sound, FIGS. 1-3 illustrate different manners of altering the timbre by filtering the signal or sound as is preferred at start-up of the system.

FIG. 1 illustrates a low-pass filter with a cut-off frequency Fc, where Fc is altered over time from an initial Fc, preferably 3000 Hz, to a Target Fc, preferably 20000 Hz. This altering may be stepwise or continuous over the period of time.

Increasing Fc over time reduces the effect of the filter and thus brings the sound output closer to the intended, unfiltered sound.

FIG. 2 illustrates a high-pass filter with a cut-off frequency Fc, where Fc is altered over time from an initial Fc, preferably 300 Hz, to a Target Fc, preferably 20 Hz. This altering may be stepwise or continuous over the period of time.

Reducing Fc over time reduces the effect of the filter and thus brings the sound output closer to the intended, unfiltered sound.

FIG. 3 illustrates a band-pass filter with upper and lower cut-off frequencies Fu and Fl, respectively, which are altered over time from initial values to target values. This altering may be stepwise or continuous over the period of time.

The band-pass filter is a combination of a high-pass filter and a low-pass filter, and decreasing FI and increasing Fu over time reduces the effect of the filter and thus brings the sound output closer to the intended, unfiltered sound.

FIG. 4 illustrates a typical audio set-up for use in a living room, a car or the like. Several different playback modes exist, for example: mono, stereo, 3.0, 4.0, 5.1, 7.1, where more and more speakers are involved, and where subwoofers may be used also. The set-up of FIG. 4 has 7 speakers. A subwoofer may also be used, but it is not illustrated.

In FIG. 4, a controller or media centre 44 is illustrated. This controller accesses or receives the audio to be provided and generates the signals for the individual speakers 30 (centre speaker), 32/34 (front speakers), 36/38 (side speakers) and 40/42 (back speakers).

The controller 44 may access audio files stored therein or accessible via a local network or the internet. Alternatively, the controller may receive streamed audio in the form of radio channels, audio databases, such as ITunes®, TV channels or the like, such as from the internet or an antenna.

The controller is able to adapt the timbre of the audio received or accessed. Preferably, this adaptation is performed in filters. The signal adaptation of the controller 44 is illustrated in FIG. 5 for the signal for one of the speakers.

In FIG. 5, the audio signal as accessed or received is fed to a processor 46, such as an FPGA, an ASIC or a DSP, which generates or derives there from the signals for each of the speakers. The signal for a speaker is then fed to a filter 48, which performs the desired timbre adaptation and feeds the resulting signal to a pre-amplifier 50, controlling the signal strength of the sound output of the speaker. The pre-amplified signal is fed to an amplifier 58 and there from to the speaker. Naturally, the filter 48 may be provided also at other positions in this set-up.

The processor 46 may receive inputs from the user, such as desired filtering information, power up/down instructions, volume information (how loud should the sound be), when a change in mode (such as a change in the number of speakers used) takes place, or the like. Also, the processor 46 may access all available audio, so that the instructions for selecting audio is also fed to the processor.

In operation, it is desired that the timbre adaptation starts when the system is turned on. Thus, initially, no sound is provided by the speakers, and when the user enters the power-on instruction, such as by engaging a power button, the filters 48 perform the filtering as described but over time reduce the effect on the signal so that after a period of time, no filtering is performed, and the signal fed to the pre-amplifier 50 is that fed to the filter 48. Naturally, filtering may be performed for other reasons, as is usual in media players. Filters may be employed to adapt the overall sound of the system to the surroundings (room or cabin of a car). This filtering is performed after but usually also during the timbre adaptation performed by the filter 48. All filtering may be performed by the filter 48, or an additional filter may be used for the sound adaptation.

Clearly, the set-up described provides a wide range of operations at start-up, as the speakers may be operated (fed signals) simultaneously or sequentially. Also, the filtering (timbre adaptation) may be identical for all speakers or may be faded out sequentially for the speakers. Combinations also exist.

The sequential operation of the speakers (which is also described in the Applicant's co-pending application PCT/EP2010/068989) may be the controlling of the pre-amplifiers 50 to firstly increase the signal strength of the centre speaker 30, then the front speakers 32/34, the side speakers 36/38 and finally the back speakers 40/42, so that the sound will seem to come from in front and then “surround” the user 20.

At the same time, the filters 48 be controlled to either maintain the maximum timbre adaptation (largest filtration) until all speakers are active and then reduce the timbre adaptation, or coordinate the filtering so that each speaker receives a signal with the same time-dependent timbre adaptation, but as the speakers are operated in sequence, the timbre adaptation of the speakers is equally operated in sequence. Thus, firstly, the centre speaker 30 will be operated and have the timbre adaptation reduced, usually while the front speakers 32/34 start to operate, etc, and the front speaker 30 then will be the first speaker to provide the sound without timbre adaptation.

The same effect, now reversed in time, may be performed at shut-down of the system.

Thus, when the system is to shut down, such as when the user operates the power button, the timbre adaptation of the filter 48 is increased from no effect/filtering to the maximum effect/filtering over a period of time. Finally, no signal is fed to the speakers which then are silent.

Again, this timbre adaptation may be performed simultaneously for all speakers, such as coordinated with a reduction (control of the pre-amplifier 50) of the signal strength of the sound output.

Alternatively, the speakers may sequentially output reduced sound intensity so that, firstly, the back speakers 40/42 will start to reduce the signal strength, where after the side speakers 36/38, then the front speakers 32/34 and finally the centre speaker 30 will reduce in intensity and eventually become silent.

As described above, this sequential sound reduction may be coordinated with an increased filtering so that the timbre adaptation of a speaker increases while the sound intensity is reduced. This then will be performed sequentially for the speakers.

Instead of or in addition to the operation of the timbre adaptation at power-up/down, this effect may also be activated when, e.g., a) automatically when a car having the system is entered or the motor is started, or b) upon a specific control command given by the user, c) automatically when a utility device is activated e.g. a loudspeaker is brought into a specific position or the like.

1. A method of providing audio from a stereo, TV or media player comprising one or more speakers, the method comprising:
initially, when the stereo/TV/media player is turned off or powered down providing no sound from the speaker(s),
after step 1. providing sound relating to a track characterized by a predetermined signal, step 2 comprising: initially providing the sound by bandwidth limiting the predetermined signal and feeding the bandwidth limited signal to the speaker(s) and subsequently feeding the predetermined signal to the speaker(s), step 2 taking between 1 and 30 seconds and being performed or initiated in connection with a start-up or power-on of the stereo/TV/media player.

2. A method according to claim 1, wherein the bandwidth limiting step comprises filtering the signal in a band pass filter.

3. A method according to claim 1, wherein the bandwidth limiting step comprises reducing frequencies of the signal having a frequency exceeding a higher threshold frequency.

4. A method according to claim 3, wherein the bandwidth limiting step comprises increasing, during a first predetermined period of time, the higher threshold from a first lower limit to a first upper limit.

5. A method according to claim 1, wherein the bandwidth limiting step comprises reducing frequencies of the signal having a frequency being lower than a lower threshold frequency.

6. A method according to claim 5, wherein the bandwidth limiting step comprises decreasing, during a second predetermined period of time, the lower threshold from a second higher limit to a second lower limit.

7. A method according to claim 1, wherein the bandwidth limiting step comprises increasing, during a third predetermined period of time, an overall signal intensity of the signal fed to the speaker(s).

8. A method according to claim 1, for providing audio from a plurality of speakers, wherein the bandwidth limiting step comprises increasing, during a fourth predetermined period of time, a number of the speaker(s) to which the bandwidth limited signal is fed.

9. A radio, TV or media player for providing audio from one or more speakers, the radio/TV/media player comprising:
a signal provider able to access a track to be provided and output a corresponding signal,
a receiver for receiving a power-on instruction,
a filter for filtering the output signal and provide a filtered, bandwidth limited signal to the speaker(s), the filter being configured to
initially provide no signal to the speaker(s),
after step 1. initially filter the output signal for between 1 and 30 seconds and feed the filtered signal to the speaker(s) and subsequently feed to the speaker(s), as the filtered signal, the output signal without filtering it step 2 being performed or initiated in connection with when the receiving means receives a power-on instruction.

10. A radio/TV/media player according to claim 9, wherein the filter is a band pass filter.

11. A radio/TV/media player according to claim 9, wherein the filter is a low pass filter.

12. A radio/TV/media player according to claim 11, wherein the filter is configured to, during step 2. and during a first predetermined period of time increase a threshold frequency of the low pass filter.

13. A radio/TV/media player according to claim 9, wherein the filter is a high pass filter.

14. A radio/TV/media player according to claim 13, wherein the filter is configured to, during step 2. and during a second predetermined period of time decrease a threshold frequency of the high pass filter.

15. A radio/TV/media player according to claim 9, wherein the filter is configured to, during during a third predetermined period of time of step 2. increase an overall signal intensity of the filtered signal fed to the speaker(s).

16. A radio/TV/media player according to claim 9, comprising a plurality of speakers, wherein the filter is configured to increase, during a fourth predetermined period of time, a number of the speaker(s) to which the filtered signal is fed.

17. A method of providing audio from a stereo, TV or media player comprising one or more speakers, the method comprising:
initially providing sound from the speaker(s), the sound relating to a track characterized by a predetermined signal,
after step 1. initially providing the sound by bandwidth limiting the signal and feeding the bandwidth limited signal to the speaker(s) for between 1 and 30 seconds and subsequently feeding no signal to the speaker(s), step 2 being performed or initiated in connection with a shut-down or power-off of the stereo/TV/media player.

18. A method according to claim 17, wherein the bandwidth limiting step comprises decreasing, during a third predetermined period of time, an overall signal intensity of the signal fed to the speaker(s).

19. A method according to claim 17, for providing audio from a plurality of speakers, wherein the bandwidth limiting step comprises decreasing, during a fourth predetermined period of time, a number of the speaker(s) to which the bandwidth limited signal is fed.

20. A radio, TV or media player for providing audio from one or more speakers, the radio/TV/media player comprising:
a signal provider able to access a track to be provided and output a corresponding signal,
shut-down element for shutting down the radio/TV/media player,
a filter for filtering the output signal and provide a filtered, bandwidth limited signal to the speaker(s), the filter being configured to
initially provide the output signal the speaker(s) without filtering it,
after step 1. initially filter the output signal and feed the filtered signal to the speaker(s) and subsequently feed no signal to the speaker(s), step 2 being performed for between 1 and 30 seconds and being initiated at shut-down of the radio/TV/media player.

21. A radio/TV/media player according to claim 20, wherein the filter is configured to, during a third predetermined period of time of step 2. decrease an overall signal intensity of the filtered signal fed to the speaker(s).

22. A radio/TV/media player according to claim 20, comprising a plurality of speakers, wherein the filter is configured to decrease, during a fourth predetermined period of time, a number of the speaker(s) to which the filtered signal is fed.
